(19) United States
(12) Patent Application Publication
(10) Pub. No.: US 2018/0122570 A1
(43) Pub. Date: May 3, 2018

(54) BONDED PERMANENT MAGNETS PRODUCED BY BIG AREA ADDITIVE MANUFACTURING

(71) Applicants: UT-Battelle, LLC, Oak Ridge, TN (US); Iowa State University Research Foundation, Inc., Ames, IA (US); Magnet Applications Inc., DuBois, PA (US)

(72) Inventors: Ling LI, Austin, TX (US); Mariappan Parans PARANTHAMAN, Knoxville, TN (US); Vlastimil KUNC, Knoxville, TN (US); Brian K. POST, Knoxville, TN (US); Orlando RIOS, Knoxville, TN (US); Robert H. FREDETTE, DuBois, PA (US); John ORMEROD, Loudon, TN (US); Cajetan Ikenna NLEBEDIM, Ames, IA (US); Thomas LOGRASSO, Ames, IA (US)

(21) Appl. No.: 15/796,041

(22) Filed: Oct. 27, 2017

Related U.S. Application Data
(60) Provisional application No. 62/413,643, filed on Oct. 27, 2016.

(51) Int. Cl. H01F 41/02; H01F 1/057; B29C 64/118; B33Y 10/00

(52) U.S. Cl. CPC H01F 41/0253; H01F 1/057; B29K 2063/00; B33Y 10/00; B29C 64/118

(57) ABSTRACT

A method for producing a bonded permanent magnet by additive manufacturing, comprising: (i) incorporating components of a solid precursor material into at least one deposition head of at least one multi-axis robotic arm of a big area additive manufacturing (BAAM) system, the components of the solid precursor material comprising a thermoplastic polymer and hard magnetic powder; said deposition head performs melting, compounding, and extruding functions; and said BAAM system has an unbounded open-air build space; and (ii) depositing an extrudate of said solid precursor material layer-by-layer from said deposition head until an object constructed of said extrudate is formed, and allowing the extrudate to cool and harden after each deposition, to produce the bonded permanent magnet. The resulting bonded permanent magnet and articles made thereof are also described.

### CROSS REFERENCE TO RELATED APPLICATION

The present application claims benefit of U.S. Provisional Patent Application No. 62/413,643, filed on Oct. 27, 2016, all of the contents of which are incorporated herein by reference.

### STATEMENT REGARDING FEDERALLY SPONSORED RESEARCH

This invention was made with government support under Prime Contract No. DE-AC05-00OR22725 and DE-AC02-07CH11358 awarded by the U.S. Department of Energy. The government has certain rights in the invention.

### FIELD OF THE INVENTION

The present invention relates generally to bonded permanent magnets and methods for producing them. The invention also relates to additive manufacturing methods, particularly big area additive manufacturing (BAAM).

### BACKGROUND OF THE INVENTION

Permanent bonded magnets are well known. Bonded permanent magnets are typically fabricated by blending magnetic powders with a polymer as binder, and then molding the blend into desired shapes utilizing several commercial processing methods including injection molding, compression molding, extrusion, and calendering. Recently, bonded permanent magnets have experienced accelerated industrial applications due to their advantages, such as ability to be produced in intricate shapes, low weight and cost, superior mechanical properties and corrosion resistance. Nd₂Fe₁₄B is a particularly well known permanent magnet used in many industrial applications. Nd₂Fe₁₄B is known to adopt a tetragonal crystal structure (P42/mnm) with the easy magnetic axis along the c axis (Herbst, J. F., et al. Phys. Rev. B. 29, 4176-4178, 1984). Nd₂Fe₁₄B possesses a magnetic energy as large as 512 kJ/m³ (64 MGOe), with a Curie temperature T_{c}=585 K and a high magnetic anisotropy constant K₁ of 4.5 MJ/m³ arising from the strong spin-orbit coupling in Nd (Sagawa, M., et al. J. Appl. Phys. 57, 4094, 1985). Magnet powder properties, processing temperature, loading factor, magnet density and degree of orientation are critical process variables for improving magnetic and mechanical properties of NdFeB bonded magnets.

However, current methods for producing them are being significantly challenged by an increasing demand for bonded permanent magnets of various intricate shapes and sizes, and with higher mechanical and magnetic field strengths. Although some additive manufacturing methods, such as binder jetting, have been attempted for producing bonded permanent magnets, the bonded magnet often exhibits sub-standard hard magnetic properties due to limitations in producing sufficiently dense parts. Considering the above, there would be a significant advantage in a method that could produce permanent bonded magnets of any desired shape, intricacy, and size, and with higher than conventional mechanical strengths and magnetic field strengths.

### SUMMARY OF THE INVENTION

The present disclosure is directed to methods for producing permanent bonded magnets of any of a variety of shapes, sizes, and intricacies, and with exceptional mechanical and magnetic field strengths. In the method, a precursor material containing a thermoplastic polymer and particles having a hard magnetic material composition is used as feedstock in a big area additive manufacturing (BAAM) system to produce a bonded permanent magnet. By virtue of the unbounded build space afforded by the BAAM system, a bonded permanent magnet of unlimited size can be produced, or alternatively, a structure of unlimited size (e.g., a motor, engine, vehicle, or industrial machine) and shape can be produced in which a component of the structure is magnetic.

In particular embodiments, the method includes: (i) incorporating components of a solid precursor material into at least one deposition head of at least one multi-axis robotic arm of a big area additive manufacturing (BAAM) system, the components of the solid precursor material comprising a thermoplastic polymer and particles having a hard magnetic material composition, wherein the thermoplastic polymer has a melting point of at least 175° C.; the deposition head performs melting, compounding, and extruding functions; and the BAAM system has an unbounded open-air build space; and (ii) depositing an extrudate of the solid precursor material from the deposition head, the extrudate being at a temperature above the glass transition temperature of the solid precursor material when exiting an orifice of the deposition head, and depositing the extrudate layer-by-layer from the deposition head until an object composed of the extrudate is formed. In the layer-by-layer deposition, the extrudate is allowed to cool after each deposition to produce the bonded permanent magnet. The method advantageously provides a bonded permanent magnet that retains the magnetic properties of the particles having a hard magnetic material composition with substantially no loss (e.g., up to or less than 5% loss) in the magnetic properties.

### BRIEF DESCRIPTION OF THE FIGURES

FIG. 1. Schematic of an exemplary melt and extrude process. Underneath the nozzle is a printed magnet in a hollow cylinder shape with an OD×ID of ˜4.5 inch×3 inch.

FIGS. 2A-2D. Graphs showing magnetic properties of Big Area Additive Manufacturing (BAAM) and Injection Molding (IM) fabricated NdFeB bonded magnets. FIG. 2A: Room temperature de-magnetization curves (MH and BH) for both BAAM and IM magnets. FIG. 2B: room temperature maximum energy product for BAAM and IM magnets. FIG. 2C: Demagnetization curves for BAAM magnets measured at elevated temperatures from 300 K to 400 K. FIG. 2D: Maximum energy product as a function of temperature for BAAM magnet. Note that there are two sets of units in magnetism: SI and CGS. Conversion for some frequently used units are: 10 kG=1 T; 1 Oe=79.6 A/m; 1 MGOe=7.96 kJ/m³, and B (G)=H (Oe)+4 M (emu/cm³).

FIGS. 3A, 3B. Graphs showing thermal stability of the BAAM magnets. FIG. 3A: Flux aging loss for BAAM magnet as a function of aging time (0-1000 h). FIG. 3B: Temperature (350 K, 400 K, and 450 K) after 200 hours of exposure.

FIGS. 4A-4C. SEM micrographs. FIG. 4A: the starting composite pellets. FIG. 4B: the BAAM printed bonded magnets. FIG. 4C: the fractured surface of the BAAM magnets after tensile testing.

FIG. 5. Mechanical properties of the BAAM fabricated NdFeB magnets (#1-#4 as indicated in Table 2) measured at room temperature. Tensile stress-strain curves of the BAAM fabricated Nd—Fe—B magnets corresponding to the inset shows the images of the four samples after tensile testing, indicating the location of failure.

FIG. 6. Room temperature demagnetization curve of a 70 vol. % BAAM-fabricated Nd—Fe—B bonded magnet.

FIGS. 7A, 7B. Flux aging loss for 70 vol. % BAAM-fabricated magnets as a function of aging time (0-1000 hours) for as-printed samples at various temperatures (FIG. 7A), and as-printed and coated samples at 127° C. (FIG. 7B). All the samples were rectangular shaped with a consistent permanence coefficient (PC) of 2.

FIGS. 8A, 8B. Scanning electron microscopy (SEM) images of the 70 vol. % BAAM-fabricated magnets: cross section of the as-printed sample (FIG. 8A), and fractured surface (FIG. 8B).

FIG. 9. Plot of the eddy current loss fraction of 70 vol. % BAAM-fabricated magnets and sintered anisotropic Neo VS-11 magnets.

FIG. 10. Graph comparing the back electromotive force (back—EMF) vs. motor speed for motors installed with the original ferrites (right image of the inset) and the 70 vol. % BAAM-fabricated magnets (left image of the inset). The inset shows the back-to-back motor testing configuration.

### DETAILED DESCRIPTION OF THE INVENTION

In the disclosed process, a material containing a thermoplastic polymer (i.e., “polymeric binder”) and particles having a hard magnetic material composition (i.e., magnetic particles) is employed as a solid precursor material (i.e., feed) in a BAAM process. As well known in the art, the BAAM process employs an unbounded open-air build space in which at least one, and typically, a multiplicity, of deposition heads controlled by one or a multiplicity of multi-axis robotic arms operate in concert to construct an object. In the BAAM process, the feed material is processed within and ultimately deposited from the deposition head layer-by-layer as an extrudate, which cools over time to produce the bonded permanent magnet. The BAAM process considered herein may use only the hard magnetic precursor material as feed for the entire BAAM process, or the BAAM process may employ the hard magnetic precursor material as feed in one or more deposition heads and may employ another (non-magnetic) feed in one or more other deposition heads to construct an object with magnetic and non-magnetic portions. As well known, the deposition head in a BAAM process is designed to combine melting, compounding, and extruding functions to produce and deposit an extrudate of the precursor material layer-by-layer. The deposition heads are moved and precisely positioned by the multi-axis robotic arm, which can be either stationary or mounted on a multi-axis or conventional three-axis gantry system. The multi-axis robotic arms are, in turn, instructed by a computer program, as generally provided by a computer-aided manufacturing (CAM) software package. As also well known, in the BAAM process, one deposition head may be partly or solely responsible for building a specific region of the overall object, but generally coordinates with at least one other deposition head, which is involved in building another region of the overall object. The BAAM process is described in detail in, for example, C. Holshouser et al., Advanced Materials & Processes, 15-17, March 2013, and M. R. Talgani et al., SAMPE Journal, 51(4), 27-36, July/August 2015, the contents of which are herein incorporated by reference in their entirety.

The thermoplastic polymer can be any polymer that can be melted, compounded, and extruded in the deposition head of a BAAM system. The thermoplastic polymer should also have the ability to harden after deposition and cooling. For purposes of the invention, the thermoplastic polymer preferably has a melting point of at least or above 175° C., 180° C., 185° C., 190° C., 195° C., 200° C., 225° C., 250° C., 275° C., or 300° C. Some examples of such thermoplastic polymers include polyamides (e.g., Nylon 6,6), polyphenylene sulfide, polyphenylene oxide, acrylonitrile butadiene styrene, polyether ether ketone, polyoxymethylene, polyether sulfone, polycarbonates, polyetherimide, polyvinyl addition polymers (e.g., polyacrylonitrile, polyvinylchloride, polytetrafluoroethylene, and polystyrene), polyesters, and polybenzimidazole. In some embodiments, the thermoplastic polymer is a homopolymer, which may have any of the above compositions. In other embodiments, the thermoplastic polymer is a copolymer, which may be, for example, a block, alternating, random, or graft copolymer.

In some embodiments, the thermoplastic polymer is crosslinkable. In more particular embodiments, the thermoplastic crosslinkable polymer behaves as a pliable thermoplastic material at relatively low temperature during deposition of the precursor material, while being able to transform into a hardened durable non-pliable thermoset state after deposition and construction of the magnetic object. The thermoplastic crosslinkable polymer (i.e., polymeric binder) has a characteristic of a delayed crosslinking reaction to the extent that a majority of the crosslinking occurs after the solid precursor material has been melted, extruded, and deposited on a substrate. By virtue of this crosslinking ability, the polymeric binder functions initially as a thermoplastic and then as a thermoset after crosslinking. Thus, the polymeric binder can be considered a hybrid polymer, i.e., having characteristics of both a thermoplastic and a thermoset. However, at the thermoset stage, the polymeric binder forms a three-dimensional covalent network, and thus, cannot revert back to a thermoplastic state, as expected for a thermoset polymer. In some embodiments, the thermoplastic polymer is not crosslinkable.

In order to possess this hybrid characteristic, the polymeric binder possesses groups that ultimately undergo crosslinking, either with the same or other groups in the same polymer, or with the same or other groups in a different polymer or compound (e.g., a rapid or latent crosslinking agent) that has been admixed with the polymeric binder. In conventional fused deposition modeling (FDM), the polymer feed material is simply melted and extruded directly onto a cold or warm plate, or onto a prior build layer. These applications require materials that are spatially locked in place immediately after deposition and maintain tolerance during thermal cycling. Since out-of-the-box heating requires localized deposition of energy to promote layer-to-layer bonding, part distortion is a limiting factor when building high strength components.

The hybrid polymers exhibit a broad thermal activation window that facilitates rapid pre-polymer formation at slightly elevated temperatures without full crosslinking. The hybrid polymer is preferably a reactive polymer, such as polyurethane and/or epoxy, which may be reacted with rapid or latent crosslinking agents, such as moisture provided by a humid environment in the case of urethanes, or an aromatic amine and a polyphenol in the case of epoxies. Typical FDM employs a three-step process, namely, melt, deposit and solidify, while embodiments of this invention can include a five-step process: melt, partially crosslink to achieve desired viscosity, deposit, solidify, and initiate extensive crosslinking. In other embodiments, application of an electromagnetic field can also be used to align aromatic polymer structures for crosslinking between layers. The formation of chemical bonds across layers can improve z-strength and enable incorporation of a large fraction of second phase reinforcements, such as carbon fiber, both of which are currently limited in polymer 3D printing. The crosslinkable polymers used in the method of this invention also provide the advantage of chemically bonding (crosslinking) layers with underlying or previously deposited layers to improve inter-layer adhesion and strength of the deposited part.

The hybrid crosslinkable polymers can minimize distortion during a build, increase layer-to-layer adhesion, and/or minimize anisotropy in the part that results from poor interlayer adhesion. The traditional thermoplastic approach with FDM relies on the molten extruded material to solidify on top of a previous deposit, which is typically held at an elevated temperature, but well below the melting temperature of the material. In this condition, the interaction between the newly extruded material and previous deposit is minimal, as there is very little penetration and entanglement of molecules from the molten material into the previous deposit. Even when the previous deposit is held at an elevated temperature, the surface may become “tacky,” but the intermolecular bonding between the deposition layers remains low.

Using the hybrid polymers, the solidification process is a chemically driven polymerization process, rather than solely a thermally driven phase change as with thermoplastics. Hybrid polymers possess unique rheological characteristics well suited for additive manufacturing of bonded permanent magnets. As discussed above, the hybrid polymers are solid at room temperature and melt at elevated temperatures, yet can crosslink to form a thermoset. In embodiments of this invention, these polymers act as thermoplastics during deposition, and as thermosets after deposition. During the conventional deposition of thermosets, a monomer material is deposited in liquid form, and the crosslinking process that solidifies the thermoset material is irreversible and may be driven by time, heat, a chemical reaction, and/or irradiation. In the case of additive manufacturing according to embodiments of this invention, the concept is to crosslink the material using a chemical reaction and maintain a low temperature gradient within the part. The catalyst that initiates the crosslinking process may be, for example, a secondary chemical mixed with the deposited material during or just prior to deposition, or the crosslinking may be initiated with exposure to air.

Exemplary hybrid polymers include, for example, polyurethanes, epoxy-containing polymers, and polymers containing vinyl acetate units. The hybrid polymer may include a backbone and/or pendant groups that are aromatic, in which case the hybrid polymer may be referred to as an “aromatic polymer”. In embodiments of this invention, the polymer material is prepared with a rapid or latent crosslinking agent, such as moisture provided by a humid environment in the case of urethanes, or an aromatic amine and/or a polyphenol in the case of epoxies. The polymer can be blended with a limited quantity of a first curing agent to obtain a partially reacted pre-polymer at moderate temperatures, such as during melt extrusion, and a second less reactive curing agent, such as a phenolic curing agent, for higher temperature curing.

The particles having a hard magnetic material composition (i.e., “magnetic particles”) can have any suitable particle size, but typically no more than or less than 1 mm, 0.5 mm, 200 microns, 100 microns, 50 microns, 1 micron, 0.5 micron, 0.2 micron, or 0.1 micron, or a distribution of particles bounded by any two of these values. The magnetic particles can be, for example, nanoparticles (e.g., 1-500 nm) or microparticles (e.g., 1-500 microns). The term “hard magnetic material composition” refers to any of the ferromagnetic or ferrimagnetic compositions, known in the art, that exhibit a permanent magnetic field with high coercivity (i.e., without a continuous current supply), generally at least or above 300, 400, or 500 Oe. Thus, the magnetic particles considered herein are not paramagnetic or superparamagnetic particles. The magnetic particles may be magnetically isotropic or anisotropic, and may have any desired shape, e.g., substantially spherical, ovoid, filamentous, or plate-like.

Typically, the permanent magnet composition is metallic or a metal oxide, and often contains at least one element selected from iron, cobalt, nickel, copper, gallium, and rare earth elements, wherein the rare earth elements are generally understood to be any of the fifteen lanthanide elements along with scandium and yttrium. In particular embodiments, the permanent magnet composition includes iron, such as magnetite, lodestone, or alnico. In other particular embodiments, the permanent magnet composition contains at least one rare earth element, particularly samarium, praseodymium, and/or neodymium. A particularly well-known samarium-based permanent magnet is the samarium-cobalt (Sm—Co alloy) type of magnet, e.g., SmCo₅ and Sm₂Co₁₇. A particularly well-known neodymium-based permanent magnet is the neodymium-iron-boron (Nd—Fe—B) type of magnet, typically having the formula Nd₂Fe₁₄B. Other rare earth-containing hard magnetic material compositions include, for example, Pr₂Co₁₄B, Pr₂Fe₁₄B, and Sm—Fe—N. The hard magnet material may or may not have a composition that excludes a rare earth metal. Some examples of non-rare earth hard magnetic materials include MnBi, AlNiCo, and ferrite-type compositions, such as those having a Ba—Fe—O or Sr—Fe—O composition. Particle versions of such magnetic compositions are either commercially available or can be produced by well-known procedures, as evidenced by, for example, P. K. Deheri et al., “Sol-Gel Based Chemical Synthesis of Nd₂Fe₁₄B Hard Magnetic Nanoparticles,” Chem. Mater., 22 (24), pp. 6509-6517 (2010); L. Y. Zhu et al., “Microstructural Improvement of NdFeB Magnetic Powders by the Zn Vapor Sorption Treatment,” Materials Transactions, vol. 43, no. 11, pp. 2673-2677 (2002); A. Kirkeminde et al., “Metal-Redox Synthesis of MnBi Hard Magnetic Nanoparticles,” Chem. Mater., 27 (13), p. 4677-4681 (2015); and U.S. Pat. No. 4,664,723 (“Samarium-cobalt type magnet powder for resin magnet”). The permanent magnet composition may also be a rare-earth-free type of magnetic composition, such as a Hf—Co or Zr—Co alloy type of permanent magnet, such as described in Balamurugan et al., Journal of Physics: Condensed Matter, vol. 26, no. 6, 2014, the contents of which are herein incorporated by reference in their entirety. In some embodiments, any one or more of the above-described types of magnetic particles are excluded from the precursor material and resulting bonded permanent magnet produced after additive manufacturing.

The magnetic particles are generally included in the solid precursor material in an amount of at least or above 20 wt. % by weight of the polymer binder and magnetic particles (or alternatively, by weight of the solid precursor material). In different embodiments, the magnetic particles are included in an amount of at least or above 20, 30, 40, 50, 60, 70, 80, 90, 92, 95, or 98 wt. %, or in an amount within a range bounded by any two of the foregoing values. Alternatively, the magnetic particles are included in the solid precursor material in an amount of at least or above 40, 45, 50, 55, 60, 65, 70, 75, or 80 vol %.

In some embodiments, the solid precursor material may or may not further include non-magnetic particles having a composition that confers additional tensile strength to the bonded magnetic after curing. The non-magnetic particles can be composed of, for example, carbon, metal oxide, or metal carbon particles. The particles may have any suitable morphology, including, for example, spheroidal particles or filaments. The particles may be present in the solid precursor material in any desired amount, e.g., at least or above 1, 2, 5, 10, 20, 30, 40, or 50 wt. %, or in an amount within a range bounded by any two of the foregoing values. The term “filament,” as used herein, refers to a particle having a length dimension at least ten times its width dimension, which corresponds to an aspect ratio (i.e., length over width) of at least or above 10:1 (i.e., an aspect ratio of at least 10). In different embodiments, the filament has an aspect ratio of at least or above 10, 20, 50, 100, 250, 500, 1000, or 5000. In some embodiments, the term “filament” refers only to particles having one dimension at least ten times greater than the other two dimensions. In other embodiments, the term “filament” also includes particles having two of its dimensions at least ten times greater than the remaining dimension, which corresponds to a platelet morphology. Notably, the magnetic particles may also (and independently) have a spheroidal, platelet, or elongated (e.g., filamentous) morphology. In some embodiments, the magnetic particles are filaments having any of the aspect ratios described above. Notably, magnetic particles having an anisotropic (e.g., elongated or filamentous) shape are generally more amenable to alignment in a directional magnetic field.

In particular embodiments, carbon filaments are included in the solid precursor material. The carbon filaments can be, for example, carbon fibers, carbon nanotubes, platelet nanofibers, graphene nanoribbons, or a mixture thereof. In the case of carbon fibers, these may be any of the high-strength carbon fiber compositions known in the art. Some examples of carbon fiber compositions include those produced by the pyrolysis of polyacrylonitrile (PAN), viscose, rayon, lignin, pitch, or polyolefin. The carbon nanofibers may also be vapor grown carbon nanofibers. The carbon fibers can be micron-sized carbon fibers, generally having inner or outer diameters of 1-20 microns or sub-range therein, or carbon nanofibers, generally having inner or outer diameters of 10-1000 nm or sub-range therein. In the case of carbon nanotubes, these may be any of the single-walled or multi-walled carbon nanotubes known in the art, any of which may or may not be heteroatom-doped, such as with nitrogen, boron, oxygen, sulfur, or phosphorus. The carbon filament, particularly the carbon fiber, may possess a high tensile strength, such as at least 500, 1000, 2000, 3000, 5000, or 10,000 MPa. In some embodiments, the carbon filament, particularly the carbon fiber, possesses a degree of stiffness of the order of steel or higher (e.g., 100-1000 GPa) and/or an elastic modulus of at least 50 Mpsi or 100 Mpsi.

In other embodiments, metal oxide filaments may or may not be included in the solid precursor material. The metal oxide filaments (also known as metal oxide nanowires, nanotubes, nanofibers, or nanorods), if present, can be, for example, those having or including a main group metal oxide composition, wherein the main group metal is generally selected from Groups 13 and 14 of the Periodic Table. Some examples of Group 13 oxides include aluminum oxide, gallium oxide, indium oxide, and combinations thereof. Some examples of Group 14 oxides include silicon oxide (e.g., glass), germanium oxide, tin oxide, and combinations thereof. The main group metal oxide may also include a combination of Group 13 and Group 14 metals, as in indium tin oxide. In other embodiments, the metal oxide filaments have or include a transition metal oxide composition, wherein the transition metal is generally selected from Groups 3-12 of the Periodic Table. Some examples of transition metal oxides include scandium oxide, yttrium oxide, titanium oxide, zirconium oxide, hafnium oxide, vanadium oxide, niobium oxide, tantalum oxide, chromium oxide, molybdenum oxide, tungsten oxide, manganese oxide, iron oxide, ruthenium oxide, cobalt oxide, rhodium oxide, iridium oxide, nickel oxide, palladium oxide, copper oxide, zinc oxide, and combinations thereof. The metal oxide filament may also include a combination of main group and transition metals. The metal oxide filament may also include one or more alkali or alkaline earth metals in addition to a main group or transition metal, as in the case of some perovskite nanowires, such as CaTiO₃, BaTiO₃, SrTiO₃, and LiNbO₃ nanowires, and as further described in X. Zhu, et al., J. Nanosci. Nanotechnol., 10(7), pp. 4109-4123, July 2010, and R. Grange, et al., Appl. Phys. Lett., 95, 143105 (2009), the contents of which are herein incorporated by reference. The metal oxide filament may also have a spinel composition, as in Zn₂TiO₄ spinel nanowires, as described in Y. Yang et al., Advanced Materials, vol. 19, no. 14, pp. 1839-1844, July 2007, the contents of which are herein incorporated by reference. In some embodiments, the metal oxide filaments are constructed solely of metal oxide, whereas in other embodiments, the metal oxide filaments are constructed of a coating of a metal oxide on a non-metal oxide filament, e.g., silica-coated or germanium oxide-coated carbon nanotubes, as described in M. Pumera, et al., Chem Asian J., 4(5), pp. 662-667, May 2009, and M. Pumera, et al., Nanotechnology, 20(42), 425606, 2009, respectively, the contents of which are herein incorporated by reference. The metal oxide layer may alternatively be disposed on the surface of a metallic filament. The metal oxide filaments may also have any of the lengths and diameters described above.

In other embodiments, metal filaments may or may not be included in the solid precursor material. The metal filaments (also known as metal nanowires, nanotubes, nanofibers, or nanorods), if present, can be, for example, those having or including a main group metal composition, such as a silicon, germanium, or aluminum composition, all of which are well known in the art. The metal filaments can also have a composition having or including one or more transition metals, such as nickel, cobalt, copper, gold, palladium, or platinum nanowires, as well known in the art. The metal filaments may also be doped with one or more non-metal dopant species, such as nitrogen, phosphorus, arsenic, or silicon to result in a metal nitride, metal phosphide, metal arsenide, or metal silicide composition. Many of these doped metal compositions are known to have semiconductive properties.

The solid precursor material may or may not also include an anti-oxidant compound. The anti-oxidant is generally of such composition and included in such amount as to help protect the magnetic particles from oxidizing during the additive manufacturing process. In some embodiments, the anti-oxidant is a phenolic compound, such as phenol or a substituted phenol (e.g., 2,6-di-t-butyl-4-methylphenol). In other embodiments, the anti-oxidant is a complexant molecule, such as EDTA. The anti-oxidant is typically included in the solid precursor material in an additive amount, typically up to or less than 5, 2, or 1 wt. %.

In some embodiments, the solid precursor material may or may not include one or more additional components that desirably modulate the physical properties of the resulting melt. In particular embodiments, a plasticizer is included in the precursor material, typically to promote plasticity (i.e., fluidity) and to inhibit melt-fracture during the extrusion and deposition process. The one or more plasticizers included in the precursor material can be any of the plasticizers well known in the art and appropriate for the particular polymer being extruded. For example, in a first embodiment, the plasticizer may be a carboxy ester compound (i.e., an esterified form of a carboxylic or polycarboxylic acid), such as an ester based on succinic acid, glutaric acid, adipic acid, terephthalic acid, sebacic acid, maleic, dibenzoic acid, phthalic acid, citric acid, and trimellitic acid. In a second embodiment, the plasticizer may be an ester-, amide-, or ether-containing oligomer, such as an oligomer of caprolactam, wherein the oligomer typically contains up to or less than 10 or 5 units. In a third embodiment, the plasticizer may be a polyol (e.g., a diol, triol, or tetrol), such as ethylene glycol, diethylene glycol, triethylene glycol, glycerol, or resorcinol. In a fourth embodiment, the plasticizer may be a sulfonamide compound, such as N-butylbenzenesulfonamide, N-ethyltoluenesulfonamide, or N-(2-hydroxypropyl)benzenesulfonamide. In a fifth embodiment, the plasticizer may be an organophosphate compound, such as tributyl phosphate or tricresyl phosphate. In a sixth embodiment, the plasticizer may be an organic solvent. The organic solvent considered herein is a compound that helps to soften or dissolve the polymer and is a liquid at room temperature (i.e., a melting point of no more than about 10, 20, 25, or 30° C.). Depending on the type of polymer, the organic solvent may be, for example, any of those mentioned above (e.g., ethylene glycol or glycerol), or, for example, a hydrocarbon (e.g., toluene), ketone (e.g., acetone or butanone), amide (e.g., dimethylformamide), ester (e.g., methyl acetate or ethyl acetate), ether (e.g., tetrahydrofuran), carbonate (e.g., propylene carbonate), chlorohydrocarbon (e.g., methylene chloride), or nitrile (e.g., acetonitrile). In some embodiments, one or more classes or specific types of any of the above plasticizers are excluded from the melt. In some embodiments, the plasticizer or other auxiliary component may be removed from the extrudate by subjecting the extrudate to a post-bake process that employs a suitably high temperature capable of volatilizing the plasticizer or other auxiliary component.

In the method described herein, the solid precursor material containing the polymeric binder and magnetic particles is incorporated (fed) into one or more deposition heads of a BAAM system. Within the deposition head, the precursor material is melted and compounded before being extruded from an orifice of the deposition head. The extrudate, when exiting the orifice of the deposition head, is at a temperature above the glass transition temperature (T_{g}) of the precursor material. In some embodiments, in order to avoid a temperature that could denature the magnetic particles, the precursor material is heated to a temperature of no more than 5° C., 10° C., 15° C., or 20° C. above the glass transition temperature of the precursor material. Notably, the glass transition temperature of the precursor material is to be distinguished from the glass transition temperature or melting point of the thermoplastic polymer. In different embodiments, an extrudate of the precursor material exits the deposition head (and/or is initially deposited) at a temperature of at least 120° C., 130° C., 140° C., 150° C., 160° C., 165° C., 170° C., 175° C., 180° C., 185° C., 190° C., 195° C., 200° C., 225° C., 250° C., 275° C. or 300° C., or a temperature within a range bounded by any two of the foregoing exemplary temperatures.

The melt is extruded through a nozzle of the deposition head and deposited onto a platform from which the object will be removed, or the extrudate is deposited onto an existing portion of the object being manufactured to which the extrudate is being bonded. The extrudate is deposited layer-by-layer from the one or more deposition heads until an object is formed from the extrudate. As the extrudate exits the nozzle and is deposited, the extrudate cools, which results in solidification. In the case where a crosslinkable polymer is included in the extrudate, the deposition and cooling process leads to an increase in viscosity and a transition of the extrudate to a semi-solid or gel (i.e., a “solidified preform”). At this stage, an initial substantially incomplete level of crosslinking typically also occurs, before final hardening over time.

In some embodiments, as the extrudate exits the nozzle and is being deposited, the extrudate is exposed to a directional (external and non-varying) magnetic field of sufficient strength to align the particles having a hard magnetic composition. The alignment of the magnetic particles refers to at least an alignment of the individual magnetic fields (or poles) of the magnetic particles. In the case of anisotropically shaped magnetic particles, the alignment also involves a physical alignment, e.g., axial alignment of filamentous particles. In the case of a thermoplastic polymer containing aromatic groups, the polymer may also undergo alignment in the presence of a magnetic field by virtue of aligning and stacking of the aromatic groups. As the magnetic particles and/or thermoplastic polymer require an appreciable degree of freedom of movement to align themselves, the exposure to the directional magnetic field should occur at least during the time the precursor material is in a melted or partially melted form, i.e., before final solidification. Generally, in order for magnetic particles and/or thermoplastic polymer to sufficiently re-orient and align in the melt, the extrudate melt should possess a melt viscosity of up to or less than 20,000, 50,000, or 100,000 cPs, where cPs refers to a centipoise. However, in order to ensure that the extrudate maintains a shape when deposited, the melt on deposition should have a viscosity of at least 1,000, 2,000, 5,000, or 10,000 cPs. In order to sufficiently align the magnetic particles and/or thermoplastic polymer, the external magnetic field should generally have a magnetic field strength of at least 0.25 or 0.5 Tesla (0.25 T or 0.5 T). In different embodiments, the external magnetic field has a magnetic field strength of about, at least, above, up to, or less than, for example, 0.25, 0.5, 1, 1.2. 1.5, 2, 2.5, 3, 3.5, 4, 5, 6, 7 or 8 T.

In some embodiments, the extrudate after deposition is cooled over time, which leads to hardening and production of the hard magnetic bonded object. In the case where a crosslinkable polymer is included in the extruded, after the extrudate is deposited, and generally but not necessarily after a complete object of desired shape is constructed with the solidified preform, the solidified preform is cured by subjecting the solidified preform to conditions that result in substantial crosslinking to the extent that the thermoplastic behavior of the solidified preform transitions to thermoset behavior. At the curing stage, the transition to a thermoset generally coincides with an increase in viscosity of the solidified preform to a value substantially above 100,000 cPs, and typically, a value of at least or above 200,000, 500,000, or 1,000,000 cPs, and eventually, a transition to a completely non-flowable solid that may be characterized by the usual properties of a solid, e.g., tensile strength and elasticity.

In some embodiments, substantially complete crosslinking occurs by allowing the solidified preform to cool over time. The length of time may be any suitable period of time (e.g., hours or days) for the solidified preform to undergo substantially complete crosslinking. In other embodiments, the solidified preform is subjected to an energetic source that promotes or induces crosslinking. The energetic source may be, for example, thermal energy, electromagnetic irradiation (e.g., ultraviolet, x-ray or gamma-ray energy), or ion bombardment (e.g., electron or neutron beam irradiation).

The shape of the object that is ultimately built can be suited to any application in which a magnetic material having a significant degree of mechanical strength is desired, such as electrical motors. Although the shape of the magnetic material ultimately produced can be simple, e.g., a planar object, such as a film or coating of a desired two-dimensional shape (e.g., square or disc), the additive manufacturing process is primarily suited to the production of complex (i.e., intricate) shapes. Some examples of intricate shapes include rings, filled or unfilled tubes, filled or unfilled polygonal shapes having at least or more than four vertices, gears, and irregular (asymmetric) shapes. Other possible shapes include arcs with an angle greater than 90 degrees and less than 180 degrees, preferably in the range 120-160 degrees. The object may also be, for example, a functional motor, engine, or turbine.

In some embodiments, the bonded permanent magnet is coated with a polymer that functions to reduce exposure of the bonded permanent magnet to oxygen. The coating polymer can be, for example, an epoxy-based or silica-based polymer or hybrid thereof. In some embodiments, the coating polymer is a sol gel type of polymer, which may be a hybrid organic-inorganic polymer.

Examples have been set forth below for the purpose of illustration and to describe certain specific embodiments of the invention. However, the scope of this invention is not to be in any way limited by the examples set forth herein.

### Examples

Big Area Additive Manufacturing (BAAM) Process

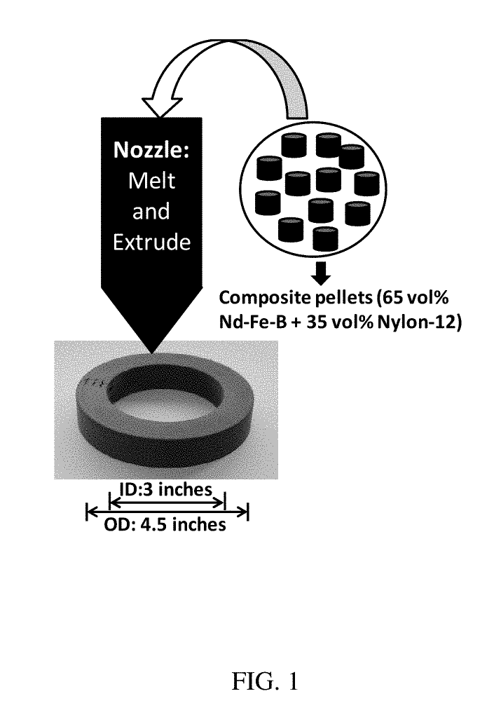

FIG. 1 shows the BAAM printing process of the bonded magnets: the nozzle deposits layers of magnetic materials which are fused together and solidify to form the desired shape. Instead of requiring pre-extruded filament feedstock commonly used in industry standard extrusion-based system, BAAM combines melting, compounding, and extruding functions to deposit polymer product at a controlled rate. The feedstock materials here are magnetic pellets composed of 65 vol % isotropic NdFeB powder (MQPB+) and 35 vol % Nylon-12. It is worth mentioning that the printing of the extruded nylon magnet composite flows even better than the widely explored 3D printing plastic filament acrylonitrile butadiene styrene (ABS), and renders high accuracy. The magnetic, mechanical, and microstructural properties of the BAAM fabricated bonded magnets are investigated and compared with respect to the traditional injection molded commercial products made from the same starting materials. The results obtained with the BAAM fabricated bonded magnets are much better than those of traditional injection molded magnets.

Three dimensional printing was performed at Manufacturing Demonstration Facility at Oak Ridge National Laboratory with the Big Area Additive Manufacturing (BAAM) system with a build volume of 3.56 m×1.65 m×0.86 m. The main components of the BAAM include the gantry system, single screw extruder, and a heated bed. The gantry uses linear drive motors to position the extruder with ±0.0254 mm accuracy and was operated at a constant velocity of 25.4 mm/s during the printing process. The extruder is 25 mm in diameter with an aspect ratio of 12 (i.e. length/diameter=12) and is used to melt nylon NdFeB composite pellets and deposit molten materials at a rate consistent with the gantry movement and desired bead profile.

The temperature at the orifice exit of the extruder was approximately 270° C. The first layer was deposited on an acrylonitrile butadiene styrene (ABS) sheet that was placed on top of the heated aluminum table kept at a constant temperature of 90° C. A hollow cylinder shape with an OD×ID of 4.5″×3″ of NdFeB (as shown in FIG. 1) was printed. In addition, a large hexagon magnet sample was also printed in order to measure the mechanical properties.

Magnetic Properties of the Bonded Permanent Magnet

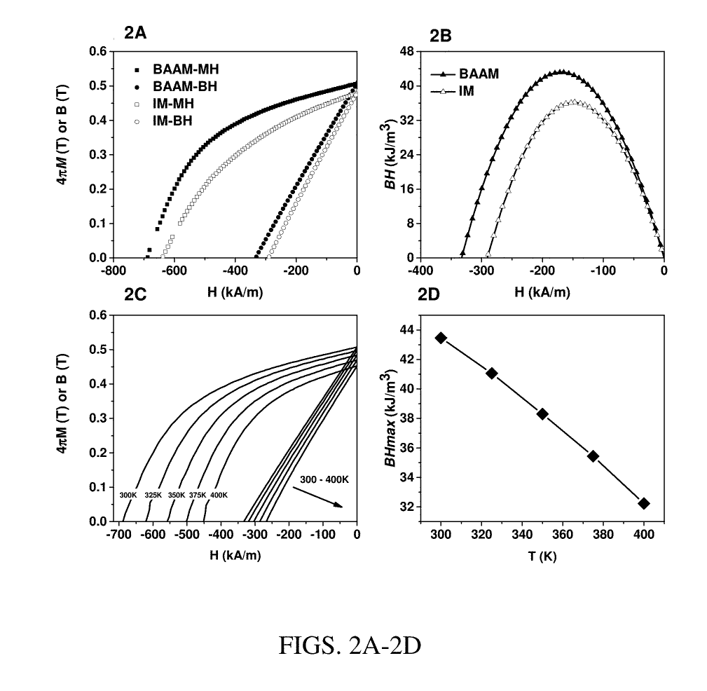

The room temperature magnetization data obtained on the BAAM and injection molded bonded magnets are shown in FIGS. 2A and 2B. FIG. 2A shows the de-magnetization curves for BAAM and IM magnets. The density of the BAAM and injection molded magnets are 4.8 g/cm³ and 4.9 g/cm³ respectively. It can be seen that both magnets retain the hard magnetic behavior of the original pellets. The magnetic properties of the BAAM magnet do not exhibit any observable degradation compared to those of the starting pellets. Moreover, the BAAM magnet shows a slightly better hysteresis loop shape in the second quadrant of the demagnetization plot, and higher H_{ci} and Bᵣ compared to the injection molded magnets. The BAAM magnet has the intrinsic coercivity H_{ci}=688.4 kA/m, remanence Bᵣ=0.51 T, and saturation magnetization 4Ms≈0.74 T.

The energy product (BH)ₘₐₓ quantifies the magnetostatic energy a permanent magnet material can store therefore characterizes how strong the magnet is. The ideal M-H hysteresis loops for a permanent magnet should be square-shaped, which gives a (BH)ₘₐₓ=¼ μ₀Jₛ², where Jₛ=4πMₛ is the saturation magnetization in unit of gauss. The M-H loops of real permanent magnet materials deviate from ideal shape, as shown in FIG. 2A, which results in a maximum achievable (BH)ₘₐₓ lower than (BH)ₘₐₓ=¼ μ0Jₛ². In fact, a balance between H_{ci}, Bᵣ, and demagnetization curve squareness is imperative to obtain high energy product. FIG. 2B presents the (BH) vs. H (−400 to 0 kA/m) for the BAAM and injection molded Nd—Fe—B magnets, whereby (BH)ₘₐₓ was determined as the maximum point in the plot. (BH)ₘₐₓ=43.49 kJ/m³ (5.47 MGOe) and 36.17 kJ/m³ (4.55 MGOe) were obtained for BAAM and IM magnets, respectively.

In real applications, the magnets are frequently exposed to elevated temperatures. Therefore, the magnetic properties of the BAAM fabricated magnets were analyzed in the temperature interval of 300 K to 400 K. FIG. 2C shows the second quadrant de-magnetization curves of BAAM printed magnet measured from 300 K to 400 K. FIG. 2D shows the variation of the energy product of the BAAM magnet with increasing temperature. The magnetic characteristics for both the BAAM and injection molded fabricated magnets are summarized in Table 1 below. It can be clearly seen that all the magnetic parameters decrease with increasing temperature, as a result of increased thermal energy disturbing the alignment of the spins. The decreasing rates for BAAM magnet are 0.34%/K, 0.11%/K and 0.26%/K for H_{ci}, Bᵣ, and (BH)ₘₐₓ, respectively. Notably, the coercivity is the magnetic field when B=0 whereas the intrinsic coercivity is the magnetic field when M=0.

TABLE 1
Magnetic properties of BAAM and IM fabricated bonded NdFeB
magnets measured at various temperatures (300 K to 400 K).

| | | | | | | 4π |
|---|---|---|---|---|---|---|
| | Temperature | H_{ci} | H_{c} | Bᵣ | (BH)ₘₐₓ | M_{3T}(T) |
| Sample | (K) | (kA/m) | (kA/m) | (T) | (kJ/m³) | (T) |
| BAAM | 300.00 | 688.37 | 357.31 | 0.51 | 43.49 | 0.74 |
| | 325.00 | 620.72 | 342.19 | 0.50 | 41.02 | 0.74 |
| | 350.00 | 557.06 | 323.89 | 0.48 | 38.32 | 0.73 |
| | 375.00 | 502.15 | 303.99 | 0.47 | 35.46 | 0.73 |
| | 400.00 | 452.01 | 281.71 | 0.45 | 32.20 | 0.72 |
| IM | 300.00 | 639.82 | 289.67 | 0.48 | 36.17 | 0.75 |
| | 325.00 | 577.75 | 274.55 | 0.47 | 33.47 | 0.74 |
| | 350.00 | 525.23 | 258.63 | 0.45 | 30.61 | 0.73 |
| | 375.00 | 479.87 | 243.51 | 0.43 | 27.59 | 0.72 |
| | 400.00 | 436.89 | 226.80 | 0.41 | 24.65 | 0.70 |

Flux Aging Loss of the Bonded Permanent Magnet

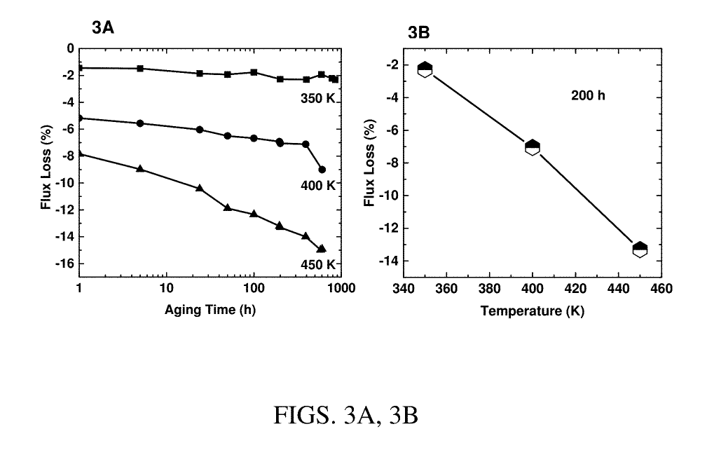

FIGS. 3A and 3B are plots of the flux aging loss of the BAAM magnet. The flux loss (%) indicates the environmental stability of the magnet, and is defined as (B_{f}−Bᵢ)/Bᵢ×100%, where B_{f} and Bᵢ are the flux density after certain duration of elevated temperature exposure and initial value, respectively. Rectangular shaped magnet specimens with approximate dimensions of 30 mm×15 mm×10 mm were used for the flux measurements. The permeance coefficients (Pc) of the specimens are approximately 0.9. FIG. 3A shows the flux loss with time for three different temperatures for up to 1000 hours. FIG. 3B shows the flux loss for BAAM magnet aged at various temperatures for 200 hours. This plot is usually used to determine the maximum operation temperature of a magnet, e.g., the aging temperature below which the magnet exhibits a flux loss below certain value (5% or 10%). The flux losses after 200 hours exposure at 350 K, 400 K, and 450 K are 2.3%, 7.1%, and 13.3% respectively, which are comparable to the flux aging loss values of the compression molded magnets made from MQPB+ powder (Ma et al., J. Magn. Magn. Mater., 239, 418-423, 2002). The magnetic flux loss is primarily related to spin relaxation and corrosion/oxidation. A high coercivity is usually required to overcome the spin relaxation at elevated temperatures. It is known that bonded magnets prepared from microdispersion coated powders exhibit improvement in flux aging loss. Hence, it is essential to optimize the starting powders in order to improve the thermal stability of the final bonded magnets.

Microstructural Analysis

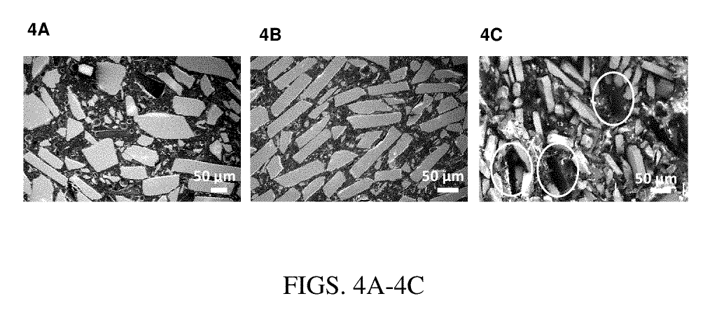

FIGS. 4A and 4B show the morphologies of the starting nylon magnet composite pellets used for printing and the BAAM fabricated bonded magnet, respectively. The plate-shaped magnetic particles (bright), which have sizes in the range of 20-200 jam, are separated by nylon polymer binder (dark). It can be observed that the magnetic particles in the printed magnet are preferentially aligned, possibly due to melting and extrusion during printing. Each particle of MQPB+ powder is isotropic and made up of many submicron grains. So while the alignment may influence mechanical properties compared to injection molded magnets, the alignment should not influence the magnetic properties in terms of Bᵣ. It is possible that the slight increase in H_{ci} for BAAM magnets compared to IM magnets, as observed in FIG. 2A, is due to the presence of shape anisotropy (FIG. 4B).

Mechanical Properties of the Bonded Permanent Magnet

Polyphenylene-sulfide (PPS) and polyamide (Nylon) are the two commonly used polymer binders for bonded magnets production. It has been found that PPS based magnets usually exhibit higher ultimate strengths, higher temperature operation but lower ductility than Nylon based magnets (Garrell et al., Mater. Sci. Eng. A, 359, 375-383, 2003). The Nylon polymer used in this work is Nylon-12, which is a thermoplastic binder with a melting point of 177° C. This type of binder usually offers the material superior mechanical flexibility and improves corrosion resistance (Ormerod et al., J. Appl. Phys., 4816, 81, 1997).

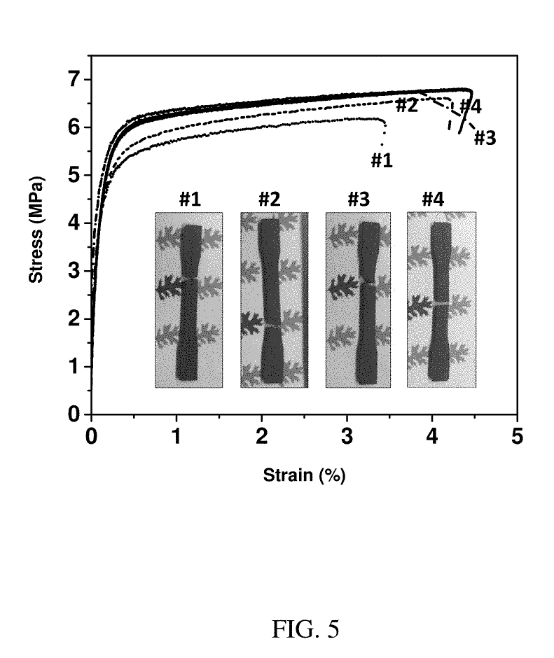

FIG. 5 presents the room temperature tensile stress-strain curves of four BAAM fabricated Nd—Fe—B magnets. Four dog-bone shaped specimens (specimens #1-#4) were tested in order to determine the degree of variability in microstructure and mechanical properties between samples. Note that the “tails” at the end of the curve in FIG. 5 are associated with the test conditions. Specimen #4 was not unloaded in a controlled manner as in the other three specimens. It can be seen that the materials exhibited a well-defined linear regime followed by ductile behavior before failure. The inset to FIG. 5 shows images of the four specimens after tensile testing indicating the location of failure. The BAAM magnets have an average Young's modulus of 4.29 GPa, ultimate tensile strength of 6.60 MPa, and ultimate strain of 4.18%. Details for each sample are given in Table 2 below. The small standard deviation for all the three characteristics indicates good uniformity between samples. For comparison, Nylon-11 based injection molded NdFeB magnets made with 62 vol % spherical powders were found to exhibit similar mechanical properties with an ultimate tensile strength of 5 MPa, and an ultimate strain of 4.6% (Garrell et al., supra). Notably, the mechanical strength of NdFeB bonded magnets significantly depends on the magnetic powder loading fraction and also the shape of the powder. Garrell et al. (supra) has shown that magnets made of irregular melt-spun powders exhibited higher tensile strength compared to those made from atomized spherical powders.

TABLE 2
Mechanical properties of BAAM fabricated bonded NdFeB
magnets measured at room temperature

| | | Ultimate Tensile | |
|---|---|---|---|
| | Modulus [GPa] | Strength [MPa] | Ultimate Strain [%] |
| #1 | 4.53 | 6.81 | 4.43 |
| #2 | 4.42 | 6.62 | 4.23 |
| #3 | 4.48 | 6.20 | 3.45 |
| #4 | 3.74 | 6.77 | 4.62 |
| Average | 4.29 | 6.60 | 4.18 |
| Std. Dev. | 0.37 | 0.28 | 0.51 |

To investigate the failure mechanism, the fracture surfaces after tensile tests were examined with SEM, as shown in FIG. 4C. Areas marked by circles are where the magnetic particles were pulled out during the tensile test, which indicates that the failure is largely due to the debonding between the magnetic particles and the nylon binder. Note that a similar failure mechanism has been reported previously for injection molded NdFeB magnets (Garrell et al., supra).

Bonded Permanent Magnet with 70 vol % Nd—Fe—B powder

To compete with injection and compression molding, which are the established methods to fabricate complex-shaped isotropic bonded magnets, an effort was made to increase the loading fraction of the magnet powder in the nylon binder in the 3D printing process to increase the magnetic strength. In this study, 70 vol. % nylon bonded Nd—Fe—B magnets were printed into various shapes. In addition, the as-printed magnets were coated with two types of epoxy-based polymers to improve their thermal stability. The microstructure, magnetic and mechanical properties, flux aging loss, and eddy current loss are reported below. The performance of the 3D printed magnets in a DC motor configuration was also demonstrated.

Computer-aided design (CAD) software was used as the first step of the 3D printing manufacturing process. The Big Area Additive Manufacturing (BAAM) printer took instructions from a CAD file to guide the printhead for layer-by-layer growth during the printing process. The geometric designs were created and saved as standard triangle language (.STL) files, which were then “sliced” in the printer software, which created the layers and path for each layer. Composite pellets made of 70 vol. % isotropic MQPB+ powder and 30 vol. % polyamide were used as the feedstock materials for the BAAM system. The material was deposited at 255° C. onto a heated print bed kept at ˜95° C. The preheating of the bed was used to enhance the bonding between layers as the beads are bonded together primarily via thermal fusion, which depends on the temperature, viscosity, and surface area. The nozzle diameter was 0.3 inch, the layer thickness was 0.15 inch, and the printing speed was 1 inch/second. The nozzle was equipped with a z-tamping attachment to obtain a leveled surface, and to strengthen the bonding between layers. More details about the compounding process of the pellet feed and the print parameters have been reported previously (L. Li, et al., Sci. Rep. 6, 36212, 2016).

The magnetic hysteresis loops were measured from 20 to 120° C.; using a closed loop magnetic hysteresis graph measurement system. Cross-sections of the as-printed sample and fractured surface were examined by scanning electron microscopy. Flux measurements were conducted using Helmholtz Coils with a fluxmeter. The samples were magnetized at 9 Tesla and then aged at elevated temperatures. The as-printed samples were treated with two types of polymer coatings to improve the thermal stability. The first type is a 3M Scotch-Weld™ DP100 epoxy (Process I), and the second type is a high temperature silica ceramic VHT™ coating (Process II). Tensile tests were performed with a screw-driven tensile testing machine at an engineering strain rate of 10⁻³s⁻¹ and temperatures of 20 and 100° C., in ambient air. Dog bone shaped samples with gauge dimension of 3.1×1.5×12.7 mm³ were used in all testing. Since the plastic deformation is limited, only the ultimate tensile stress was determined, which is calculated by the maximum load divided by the original cross-section area. Eddy current losses were estimated from AC susceptibility measurements. Resistivity measurements were achieved using a four-probe resistivity measurement setup. The 70 vol. % BAAM magnets were installed into a 12 V-750 RPM-DC motor and evaluated.

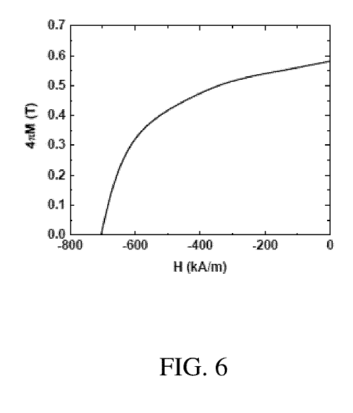

FIG. 6 shows the room temperature demagnetization curve of the 70 vol. % Nd—Fe—B bonded magnets with a density of ρ˜5.2 g/cm³. The major characteristics are Bᵣ=5.8 kG (0.58 Tesla), H_{ci}=8.9 kOe (708.2 kA/m), H_{c}=4.8 kOe (382 kA/m) and (BH)ₘₐₓ=7.3 MGOe (58.1 kJ/m₃). The injection molded magnet made from MQPB+ powders is known to have a density of ρ˜5.0 g/cm³ and (BH)ₘₐₓ of 6.2 MGOe (49.3 kJ/m³). These reduced properties result from the limitation of the loading fraction of the injection molding process, typically 65 vol. %. The loading fraction limitation is because the viscosity of the composite increases as the loading fraction increases, and this results in cavities in the injection molding process.

Table 3 (below) summarizes the magnetic characteristics of the 70 vol. % BAAM magnets at elevated temperatures up to 120° C. It is not surprising that all the characteristics decrease with increasing temperatures. The magnetic performance with increasing temperature can be evaluated from the temperature coefficients of Bᵣ, H_{ci} and (BH)ₘₐₓ, which are, as shown in Table 3, −0.18%/° C., −0.33%/° C., and −0.36%/° C., respectively. These values are also close to the reported thermal coefficients for MQPB+ powders (Ma et al., supra). In fact, the primary drawback of Nd—Fe—B magnets is the unsatisfactory magnetic performance at elevated temperatures, which is related to the relatively high temperature coefficients of Bᵣ and H_{ci}, leading to a rapid deterioration in the intrinsic coercivity and flux density. Therefore, Sm—Co magnets are frequently adopted when high temperature operation is needed.

TABLE 3
Magnetic characteristics of the BAAM printed 70 vol. % isotropic
Nd—Fe—B magnets at temperatures ranging from 20 to 120° C.

| Temperature (° C.) | Bᵣ (kG) | H_{ci} (kOe) | H_{c} (kOe) | (BH)ₘₐₓ (MGOe) |
|---|---|---|---|---|
| 20 | 5.82 | 8.85 | 4.82 | 7.25 |
| 60 | 5.10 | 7.34 | 4.01 | 5.36 |
| 80 | 4.99 | 6.92 | 3.89 | 5.12 |
| 100 | 4.91 | 6.35 | 3.77 | 4.93 |
| 120 | 4.78 | 5.92 | 3.62 | 4.64 |
| Temp Coefficient (%) | −0.18 | −0.33 | −0.25 | −0.36 |

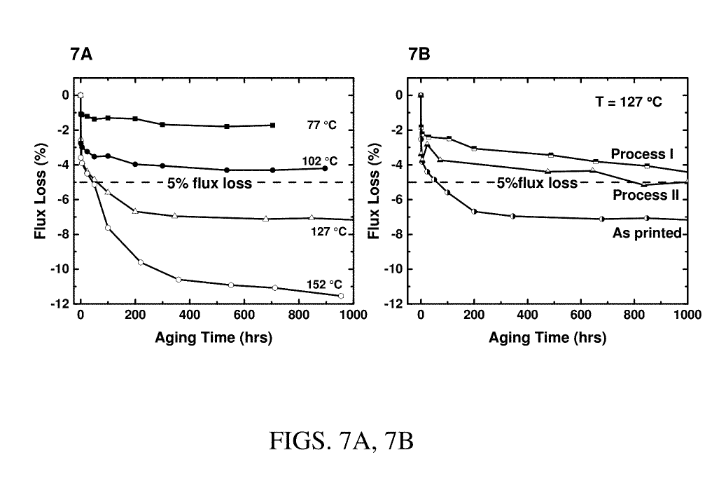

The thermal stability of magnets can also be compared by measuring the room temperature flux density of the samples before and after aging at elevated temperatures. The flux loss is related to a magnetization reversal mechanism occurring with rising temperature (Brown et al., J. Magn. Magn. Mater., 248(3), 432-440, 2002). The total flux loss is composed of recoverable loss and irreversible loss, and the latter is due to the oxidation of the Nd—Fe—B powder (Brown et al., supra). The percentage of flux loss at a certain temperature is a direct reflection of the thermal stability of the magnet. The flux aging loss with time for the as-printed 70 vol. % BAAM magnets is presented in FIG. 7A. Note that all the flux loss samples are rectangular shaped with a consistent permanence coefficient of ˜2. Industry standards dictate that magnets losing more than 5% flux density are deemed unfit for use (Noguchi et al., 2011 1st International Electric Drives Production Conference, 2011, pp. 181-186). In this sense, the maximum operating temperature for the as-printed samples is ˜110° C. In general, the temperature coefficient and/or the thermal stability of the magnets depend on the powder type and manufacturing process, such as compact pressure and temperature (Perigo et al., Powder Technol., 224, pp. 291-296, 2012). It is shown that epoxy bonded Nd—Fe—B magnets made from MQPB+ powders experienced 15% flux aging loss after being held at 180° C. for 100 hours, indicating that this powder is unsuitable for elevated temperature applications (Ma et al., supra). In general, powders with higher intrinsic coercivity H_{ci} are more suitable for high temperature applications.

One way to improve thermal stability in a bonded magnet is to prevent the magnet from being oxidized by including a protective layer either on the individual powders or on the whole magnet. In this study, the as-printed 70 vol. % BAAM magnets were coated with two types of polymers (Process I and Process II), and the flux aging loss was compared for the treated and as-printed samples, and the maximum operating temperatures were determined. Process I is a 3M Scotch-Weld™ DP100 room-temperature cured epoxy, which is commercially available and widely used due to its affordability and temperature capabilities. Process II is a high temperature silica ceramic VHT™ coating. FIG. 7B shows the flux loss after aging at 127° C. for the as-printed, Process I, and Process II treated samples. As shown, the thermal stability was most improved by treating the as-printed samples with Process I due to its effective isolation of the magnetic particles from the oxygen atmosphere. Separately, the thermal stability at 102° C. was also found to be improved with Process I coating.

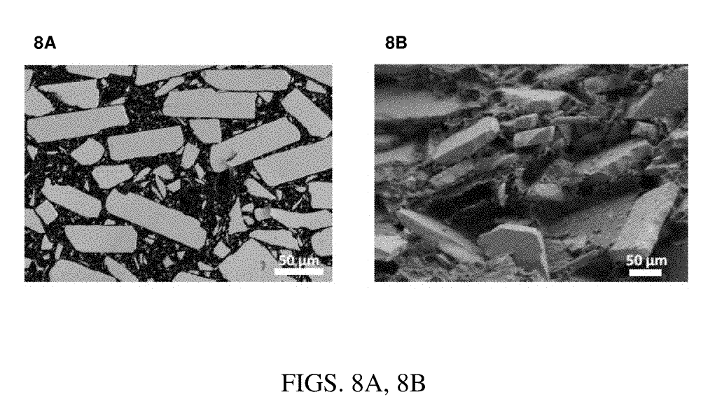

FIG. 8A is an SEM image of the polished microstructure of a 70 vol. % BAAM magnet. The magnetic particles appear as bright areas embedded in the Nylon-12 binder that appears black. The magnet particles have a flat plate-like morphology with dimensions ranging from several m up to a hundred μm. This morphology of the isotropic particles results from melt-spun ribbon cut samples. These types of powders are also used to fabricate compression molded magnets (D. N. Brown, IEEE Trans. Magn. 52(7), 1-9, 2016).

FIG. 8B shows an SEM image of the fractured surface. The magnetic particles are pulled out from the polymer binder. Table 4 (below) presents the ultimate tensile stress (UTS) and strain for BAAM printed 70 vol. % magnets in both the axial (in layer plane) and transverse directions (perpendicular to layer plane) and 65 vol. % magnets in the axial direction. Four features are noteworthy: 1) The UTS and tensile strain of BAAM magnets are close to those of injection molded magnets, namely with a room temperature UTS of 10 MPa and a strain of ˜3%; 2) The UTS is significantly direction dependent, with the transverse direction being weaker than the axial direction. This should also apply to the 65 vol. % magnet even through its transverse direction is not measured; 3) The UTS increases with increasing loading fraction. Here the axial UTS increases from 9.90 to 12.62 MPa at 25° C., and increases from 4.25 to 5.95 MPa at 100° C. when the loading is increased from 65 vol. % to 70 vol. %; 4) For a given loading fraction, the UTS decreases with increased temperature. The latter two observations are consistent with the literature values (Garrell et al., J. Magn. Magn. Mater. 257(1), pp. 32-43, 2003). Even though BAAM magnets have a much lower UTS compared to sintered magnets, they exhibit a higher degree of ductility, allowing for some plastic deformation.

TABLE 4
Mechanical properties of the 70 vol. % and 65 vol. % BAAM magnets in
both axial and transverse directions, and at 20° C. and 100° C.

| | Temperature | Ultimate Tensile Stress | Tensile Strain |
|---|---|---|---|
| Sample | (° C.) | (MPa) | (%) |
| 70 vol. % | 25 | 12.62 (0.16) | 2.14 (0.06) |
| axial | 100 | 5.95 (0.61) | 1.84 (0.16) |
| 70 vol. % | 25 | 4.65 (0.95) | 1.00 (0.19) |
| transverse | 100 | 3.00 (0.11) | 1.63 (0.16) |
| 65 vol. % | 25 | 9.90 (1.70) | 2.21 (0.39) |
| axial | 100 | 4.25 (0.09) | 3.80 (0.54) |

Even though sintered magnets offer high residual magnetic flux density which contributes to a high torque for a motor magnet, the high eddy current loss resulting from a high electrical conductivity leads to lower efficiency converting energies between magnetic and mechanical. In the present study, eddy current losses are estimated from AC magnetic susceptibility measurements where both the real (M′) and imaginary (M″) parts are measured. The imaginary part of the susceptibility M″, corresponds to dissipative losses in the sample which can result in substantial heating. In electrical conductors, the dissipation is due to eddy currents, but in ferromagnets there are additional losses such as losses due to irreversible domain wall motion or hysteresis loss.

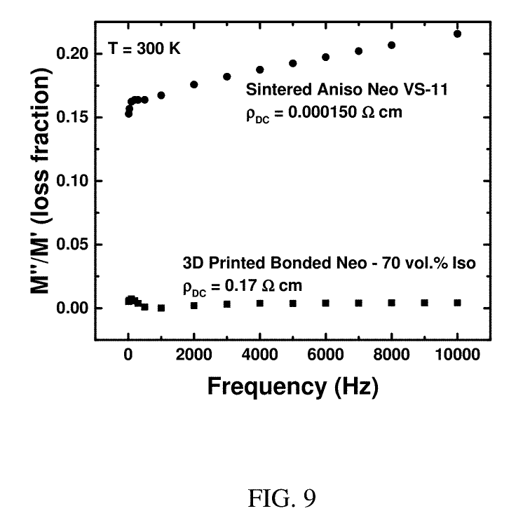

FIG. 9 plots the total loss fraction as a function of AC magnetic field frequency (amplitude of 10 Oe) for an anisotropic Nd—Fe—B sintered magnet (for comparison) and BAAM printed 70 vol. % Nd—Fe—B magnets. Both magnets were demagnetized for this measurement. The measured DC electrical resistivity, ρ, of the bonded and sintered sample is 170 mΩ·cm and 150 μΩ·cm, respectively. Since the eddy current losses are proportional to 1/ρ, the bonded magnet will have significantly less eddy current heating. This is consistent with the loss fraction of the 3D printed sample which is extremely low with M″/M′ well below 1% with increasing frequency, whereas the sintered sample exhibits a higher loss fraction of ˜20%. In the simplest models, the eddy current loss should increase as the square of the frequency. Although the losses for the sintered magnet increase with frequency, the increase is closer to linear than quadratic, indicating additional loss mechanisms or that the model is too simple. Even though the energy product of bonded magnets is sacrificed due to the incorporation of a non-magnetic polymer binder, the advantages of substantial design freedom and low eddy current loss (thus high conversion efficiency) will make 3D printed magnets rival sintered magnets for some motor applications. Furthermore, 3D printed bonded magnets, with the advantages of shape flexibility and low eddy current loss, can be applied to an axial gap motor to achieve both high torque and high efficiency (Sunita et al., Electrical Machines (ICEM), 2016 XXII International Conference, IEEE, 2016, pp. 272-278). Besides the aforementioned considerations, weight reduction is also a key advantage of bonded magnets facilitating their adoption in the automobile industry.

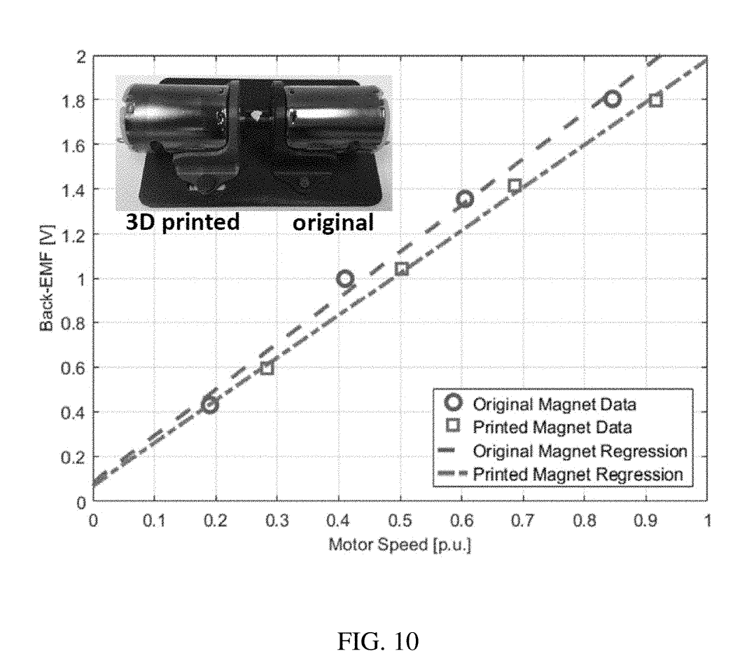

To test the applicability of the 70 vol. % BAAM magnets for motor applications, existing two arc segments of sintered ferrite magnet in a DC motor were replaced with BAAM magnets. A mounting piece was designed and 3D printed to securely hold the motors and keep the shafts concentric. The motors' back electromotive force (back-EMF) were tested in a back-to-back fashion. FIG. 10 shows the back-EMF test data for the motor installed with the original ferrite magnets and the BAAM magnets, with the back-to-back arrangement shown in the inset of FIG. 10. A voltage was applied to the motor on the right hand side to drive the motor of the left, which is the motor under test. The average output voltage of the motor under test was measured. This voltage is proportional to the flux produced by the magnets and the speed of the rotor. Given the same magnet shape, the magnitude of EMF is a reflection of the strength of the permanent magnet. It can be seen from FIG. 10 that the ferrite motor and BAAM magnet motor exhibit similar performance. The back-EMF constant (slope) of the line is 2.07V/pp. (per unit values) for the ferrite magnet motor and 1.91V/p.u. for the printed magnet motor. It should be noted that the printed magnets are slightly smaller than the original ferrite magnets, which may account for much of the 8% drop in the back-EMF as the loaded flux density depends on the magnet strength (energy product) and magnet volume. Our study shows that BAAM magnets are suitable for small motor applications. To further improve the remanence Bᵣ and energy product (BH)ₘₐₓ of 3D printed bonded magnets, a higher density (lower porosity) needs to be achieved. Optimally, in-situ magnetic alignment printing is needed to further enhance Bᵣ and thus (BH)ₘₐₓ of the printed anisotropic magnet product.

In summary, the present disclosure has described a BAAM process to fabricate near-net-shape isotropic NdFeB bonded magnets. Magnetic and mechanical characterizations demonstrate that the BAAM fabricated magnets can compete with or outperform the injection molded magnets. In addition, additive manufacturing offers significant advantages such as cost effectiveness (no tooling required), fast speed (simple procedure), and capability of producing parts of unlimited in sizes and shapes. Therefore, BAAM provides an effective method in realizing arbitrary shape with minimum cost and waste, and has the potential to revolutionize large-scale industry production of bonded magnets.

The ability to create a near-net shaped magnet results in less post processing, less (nearly zero) waste generation, and a wide range of applications for a single manufacturing platform. In the above example, nylon-bonded Nd—Fe—B magnets with a high loading fraction of 70 vol. % were fabricated via an extrusion-based additive manufacturing process for the first time. The printed magnets exhibited superior magnetic properties, compared to injection molded magnets, while maintaining substantial geometry flexibility. Motors installed with the BAAM-produced printed magnets exhibited similar performance as compared to those installed with sintered ferrites. In addition, the extrusion-based additive manufacturing method via the BAAM system can be widely applied to net-shape manufacture other functional magnets, such as SmCo, SmFeN, Fe₁₆N₂, ferrites, and hybrids of more than one composition with binder materials such as nylon, PPS (polyphenylene sulfide), and other high temperature thermoplastics.

While there have been shown and described what are at present considered the preferred embodiments of the invention, those skilled in the art may make various changes and modifications which remain within the scope of the invention defined by the appended claims.

What is claimed is:

1. A method for producing a bonded permanent magnet by additive manufacturing, the method comprising:
(i) incorporating components of a solid precursor material into at least one deposition head of at least one multi-axis robotic arm of a big area additive manufacturing (BAAM) system, the components of the solid precursor material comprising a thermoplastic polymer and particles having a hard magnetic material composition, wherein said thermoplastic polymer has a melting point of at least 175° C.; said deposition head performs melting, compounding, and extruding functions; and said BAAM system has an unbounded open-air build space; and
(ii) depositing an extrudate of said solid precursor material from said deposition head, said extrudate being at a temperature above the glass transition temperature of said solid precursor material when exiting an orifice of said deposition head, and depositing said extrudate layer-by-layer from said deposition head until an object is formed with said extrudate, and allowing the extrudate to cool after each deposition, to produce said bonded permanent magnet.

2. The method of claim 1, wherein said particles having a hard magnetic material composition are magnetically isotropic.

3. The method of claim 1, wherein said particles having a hard magnetic material composition are magnetically anisotropic.

4. The method of claim 3, wherein said extrudate is exposed to a directional magnetic field as the extrudate exits from the nozzle and is deposited, wherein said directional magnetic field is of sufficient strength to align the magnetically anisotropic particles having a hard magnetic material composition.

5. The method of claim 1, wherein said hard magnetic material composition comprises at least one element selected from iron, cobalt, nickel, and rare earth elements.

6. The method of claim 1, wherein said hard magnetic material composition contains a rare earth element.

7. The method of claim 6, wherein said hard magnetic material composition has a samarium-containing, neodymium-containing, or praseodymium-containing composition.

8. The method of claim 1, wherein said hard magnetic material composition has a Nd₂Fe₁₄B composition.

9. The method of claim 1, wherein said thermoplastic polymer has a melting point of at least 180° C.

10. The method of claim 1, wherein said thermoplastic polymer is selected from the group consisting of polyamides, polyphenylene sulfide, polyphenylene oxide, acrylonitrile butadiene styrene, polyether ether ketone, polyoxymethylene, polyether sulfone, polycarbonates, polyetherimide, polyvinyl addition polymers, polyesters, and polybenzimidazole.

11. The method of claim 1, wherein said deposition head of at least one multi-axis robotic arm coordinates with at least one other multi-axis robotic arm having another deposition head to produce said bonded permanent magnet.

12. The method of claim 1, wherein said deposition head of at least one multi-axis robotic arm follows instructions from a computer program to deposit said extrudate in precise locations.

13. The method of claim 1, wherein said bonded permanent magnet has a shape of a functional motor, engine, or turbine.

14. The method of claim 1, wherein said solid precursor material further comprises carbon particles.

15. The method of claim 14, wherein said carbon particles are carbon filaments.

16. The method of claim 1, wherein said particles having a hard magnetic material composition are included in an amount of at least 60 vol % in said solid precursor material.

17. The method of claim 1, wherein said particles having a hard magnetic material composition are included in an amount of at least 70 vol % in said solid precursor material.

18. The method of claim 1, wherein said bonded permanent magnet retains the magnetic properties of the particles having a hard magnetic material composition with substantially no loss in said magnetic properties.

19. The method of claim 1, wherein said bonded permanent magnet is coated with a polymer that functions to reduce exposure of the bonded permanent magnet to oxygen.

20. The method of claim 19, wherein said polymer is an epoxy-based polymer.
